(19) United States
(12) Patent Application Publication
(10) Pub. No.: US 2021/0356952 A1
(43) Pub. Date: Nov. 18, 2021

(54) PORTABLE DIAGNOSTIC TOOL FOR A DRIVE CONTROLLER OF A POWER-ACTUATED WORKSTATION

(71) Applicant: Leon DesRoches, Dieppe (CA)

(72) Inventor: Leon DesRoches, Dieppe (CA)

(21) Appl. No.: 17/319,818

(22) Filed: May 13, 2021

(30) Foreign Application Priority Data
May 15, 2020 (CA) 3081294

(51) Int. Cl. G05B 23/02; G06F 9/4401; G06F 9/38; G06F 8/65

(52) U.S. Cl. CPC G05B 23/0267; G05B 23/0264; G06F 8/65; G05B 23/0213; G06F 9/3836; G06F 9/4411

(57) ABSTRACT

A portable diagnostic tool includes a processor. A data port and memory are each communicatively coupled to the processor. The memory stores a plurality of computer readable instruction sets associated with different drive controller models. Each instruction set is associated with a plurality of resolution protocols. Each resolution protocol is associated with one or more commands. While the data port of the diagnostic tool is connected to a drive controller data port, the processor is configured to (i) receive an error signal from the drive controller, (ii) identify one of the plurality of instruction sets corresponding to the drive controller model that matches the drive controller, (iii) select one of the plurality of resolution protocols based on the instruction set and the error signal, and (iv) transmit, to the drive controller, the one or more commands of the selected resolution protocol instructing the drive controller to automate that resolution protocol.

### FIELD

This application relates generally to a portable diagnostic tool for a drive controller of a power-actuated workstation, and a method of resolving errors associated with a drive controller of a power-actuated workstation using a portable diagnostic tool.

### INTRODUCTION

A power-actuated workstation may include one or more actuators, such as electric motors or solenoids, that drive one or more work surfaces (e.g. tabletop or keyboard tray) to move (e.g. linearly, rotationally, or arcuately) relative to one or more axes of the workstation. For example, a sit-stand desk may include one or more vertical columns that support a tabletop and that are power extensible to move the tabletop vertically between a seated height and a standing height.

### DRAWINGS

FIG. 1 is a bottom perspective view of an example power-actuated workstation having one workstation actuator;

FIG. 2A is a side view of another example power-actuated workstation with a tabletop in a raised and rearward position;

FIG. 2B is a side view of the power-actuated workstation of FIG. 2A, with the tabletop in a raised and forward position;

FIG. 2C is a side view of the power-actuated workstation of FIG. 2A, with the tabletop in a lowered and forward position;

FIG. 2D is a side view of the power-actuated workstation of FIG. 2A, with the tabletop in a lowered and forward position;

FIG. 3 is a front perspective view of another example power-actuated workstation having two workstation actuators;

FIG. 4A is a partial perspective view of a power-actuated workstation showing an example portable diagnostic tool being connected to a drive controller data port of the power-actuated workstation;

FIG. 4B is a partial perspective view of the power-actuated workstation of FIG. 4A showing the example portable diagnostic tool connected to the drive controller data port;

FIG. 5 is a schematic illustration of a portable diagnostic tool communicatively coupled to a drive controller of a power-actuated desk, a user electronic device, and a remote storage device;

FIG. 6 is a side view of an example drive controller of a power-actuated workstation having a number of drive controller data ports, each of a different type;

FIGS. 7A-7D are top views of example portable diagnostic tools, each having a data port of a different type;

FIG. 8 is a top view of another example portable diagnostic tool having two opposed data ports, each of a different type;

FIG. 9 is a top view of the portable diagnostic tool of FIG. 7C connected to a data port adapter;

FIG. 10 is a top view of another example portable diagnostic tool connected to a user's smart phone by a cable;

FIG. 11 is a flowchart illustrating an example method of resolving an error associated with a drive controller of a power-actuated workstation;

FIG. 12 is a screenshot of an example error list that may be shown on the display of a user electronic device; and

FIG. 13 is a screenshot of an example events log that may be shown on the display of a user electronic device.

### SUMMARY

Power-actuated workstations may experience errors or encounter other problems that prevent their work surfaces from being raised and lowered. When these errors occur, the workstation user or owner often do not possess the inclination, capability and/or tools to resolve the error themselves. As a result, they often initiate a return for a replacement workstation from the distributor or manufacturer. It should go without saying that the return and replacement of such a large piece of equipment presents a number of physical challenges, logistical concerns, and/or significant transportation costs. Further, the expense of replacing the entire workstation can be a financial strain on the distributor, the manufacturer, the user, or a combination thereof, according to the terms and conditions of the workstation's warranty.

The portable diagnostic tools and methods disclosed herein may be used to resolve errors effecting the performance of a power-actuated workstation on site. For example, a manufacturer may mail a portable diagnostic tool to a user of a malfunctioning workstation. By resolving errors on site, the amount of costly and labor intensive returns may be reduced. In turn, this may lessen the financial strain placed on users, distributors and/or manufacturers, the physical and logistical challenges of returning workstations, and/or the duration for which the user may be without an operable workstation.

In a first aspect, a portable diagnostic tool is provided for a drive controller of a power-actuated workstation, the drive controller operating at least one workstation actuator. The portable diagnostic tool may include one or more processors, a memory communicatively coupled to at least one of the processors and storing a plurality of computer readable instruction sets, and at least one physical data port communicatively coupled to at least one of the processors. Each instruction set may be associated with a different drive controller model of a plurality of drive controller models. Each instruction set may be associated with a plurality of resolution protocols. Each resolution protocol may be associated with one or more commands. The at least one physical data port may be removably connectable to a corresponding physical drive controller data port. While the portable diagnostic tool is communicatively connected to the drive controller, the one or more processors are configured to collectively: (i) receive an event signal from the drive controller, (ii) identify one of the plurality of instruction sets corresponding to the drive controller model of the plurality of drive controller models that matches the drive controller, (iii) select a corresponding one of the plurality of resolution protocols based on the identified instruction set and the received event signal, and (iv) transmit, to the drive controller, the one or more commands associated with the selected resolution protocol instructing the drive controller to automate the selected resolution protocol.

In another aspect, a portable diagnostic tool is provided for a drive controller of a power-actuated workstation, the drive controller operating at least one workstation actuator. The portable diagnostic tool may include one or more processors, a memory communicatively coupled to at least one of the processors and storing a plurality of computer readable instruction sets, at least one physical data port communicatively coupled to at least one of the processors, and a user communication device communicatively coupled to the at least one processors. Each instruction set may be associated with a different drive controller model of a plurality of drive controller models. Each instruction set may be associated with a plurality of resolution protocols. Each resolution protocol may be associated with one or more user directions. The at least one physical data port may be removably connectable to a corresponding physical drive controller data port. The user communication device may be communicatively connectable to a user electronic device. While the portable diagnostic tool is communicatively connected to the drive controller and the user electronic device, the one or more processors are configured to collectively: (i) receive an event signal from the drive controller, (ii) identify one of the plurality of instruction sets corresponding to the drive controller model of the plurality of drive controller models that matches the drive controller, (iii) select a corresponding one of the plurality of resolution protocols based on the identified instruction set and the received event signal, and (iv) transmit, to the user electronic device, the one or more user directions associated with the selected resolution protocol to perform the selected resolution protocol.

In another aspect, a portable diagnostic tool is provided for a drive controller of a power-actuated workstation, the drive controller operating at least one workstation actuator. The portable diagnostic tool may include one or more processors, a memory communicatively coupled to at least one of the processors and storing a plurality of computer readable instruction sets, at least one physical data port communicatively coupled to at least one of the processors, and a user communication device communicatively coupled to the at least one processors. Each instruction set may be associated with a different drive controller model of a plurality of drive controller models. Each instruction set may be associated with a plurality of resolution protocols. Each resolution protocol may be associated with one or more commands and one or more user directions. The at least one physical data port may be removably connectable to a corresponding physical drive controller data port. The user communication device may be communicatively connectable to a user electronic device. While the portable diagnostic tool is communicatively connected to the drive controller and the user electronic device, the one or more processors are configured to collectively: (i) receive an event signal from the drive controller, (ii) identify one of the plurality of instruction sets corresponding to the drive controller model of the plurality of drive controller models that matches the drive controller, (iii) select a corresponding one of the plurality of resolution protocols based on the identified instruction set and the received event signal, (iv) transmit, to the drive controller, the one or more commands associated with the selected resolution protocol instructing the drive controller to automate a first portion of the selected resolution protocol, and (v) transmit, to the user electronic device, the one or more user directions associated with the selected resolution protocol to perform a second portion of the selected resolution protocol.

In another aspect, a portable diagnostic tool is provided for a drive controller of a power-actuated workstation, the drive controller operating at least one workstation actuator. The portable diagnostic tool may include one or more processors, a memory communicatively coupled to at least one of the processors and storing a plurality of local computer readable instruction sets, at least one physical data port communicatively coupled to at least one of the processors, and a server communication device communicatively coupled to the at least one processors. Each local instruction set may be associated with a different drive controller model of a plurality of drive controller models. Each local instruction set may be associated with a plurality of local resolution protocols. Each local resolution protocol may be associated with one or more local commands. The at least one physical data port may be removably connectable to a corresponding physical drive controller data port. The server communication device may be communicatively connectable to a server across a wireless network. While the portable diagnostic tool is communicatively connected to the drive controller and the server, the one or more processors are configured to collectively: (i) receive an event signal from the drive controller, (ii) retrieve a computer readable remote instruction set from remote network storage, the remote instruction set corresponding to the drive controller model of the plurality of drive controller models that matches the drive controller, the remote instruction set being associated with a plurality of remote resolution protocols, each remote resolution protocol being associating with one or more remote commands, (iii) select a corresponding one of the plurality of remote resolution protocols based on the identified remote instruction set and the received error signal, and (iv) transmit, to the drive controller, the one or more remote commands associated with the selected remote resolution protocol instructing the drive controller to automate the selected remote resolution protocol.

In another aspect, a method is provided for resolving an error associated with a drive controller of a power-actuated workstation, the drive controller operating at least one workstation actuator. The method may include: (i) communicatively coupling a portable diagnostic tool to the drive controller by connecting a physical data port of the portable diagnostic device to a physical data port of the drive controller, the physical data port of the diagnostic tool being communicatively coupled to one or more processors located within the portable diagnostic tool, (ii) receiving an error signal from the drive controller at the one or more processors of the portable diagnostic device by way of the physical data port of the portable diagnostic tool, (iii) identifying an computer readable instruction set from a plurality of computer readable instruction sets stored in a memory of the portable diagnostic device corresponding to a drive controller model of a plurality of drive controller models that matches the drive controller, (iv) selecting a resolution protocol for a plurality of resolution protocols stored in the memory of the portable diagnostic tool based on the identified instruction set and the received error signal, and (v) transmitting to the drive controller, by way of the physical data port of the portable diagnostic tool, one or more commands associated with the selected resolution protocol, wherein the one or more transmitted commands instruct the drive controller to automate the selected resolution protocol.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a first element is said to be ‘communicatively coupled to’ or ‘communicatively connected to’ or ‘connected in communication with’ a second element where the first element is configured to send or receive electronic signals (e.g. data) to or from the second element, and the second element is configured to receive or send the electronic signals from or to the first element. The communication may be wired (e.g. the first and second elements are connected by one or more data cables), or wireless (e.g. at least one of the first and second elements has a wireless transmitter, and at least the other of the first and second elements has a wireless receiver). The electronic signals may be analog or digital. The communication may be one-way or two-way. In some cases, the communication may conform to one or more standard protocols (e.g. SPI, I²C, Bluetooth®, or IEEE™ 802.11).

As used herein and in the claims, a group of elements are said to ‘collectively’ perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g. 112a, or 112₁). Multiple elements herein may be identified by part numbers that share a base number in common and that differ by their suffixes (e.g. 112₁, 112₂, and 112₃). All elements with a common base number may be referred to collectively or generically using the base number without a suffix (e.g. 112).

As used herein and in the claims, “up”, “down”, “above”, “below”, “upwardly”, “vertical”, “elevation” and similar terms are in reference to a directionality generally aligned with (e.g. parallel to) gravity. The terms “forward”, “forwardly” and similar terms are in reference to a directionality generally that is transverse (e.g. perpendicular) to gravity and directed away from workstation 100. Accordingly, the terms “rear”, “rearwardly” and similar terms are in reference to a directionality that is generally transverse (e.g. perpendicular) to gravity and directed towards workstation 100. However, none of the terms referred to in this paragraph imply any particular alignment between elements. For example, a first element may be said to be “vertically above” a second element, where the first element is at a higher elevation than the second element, and irrespective of whether the first element is vertically aligned with the second element.

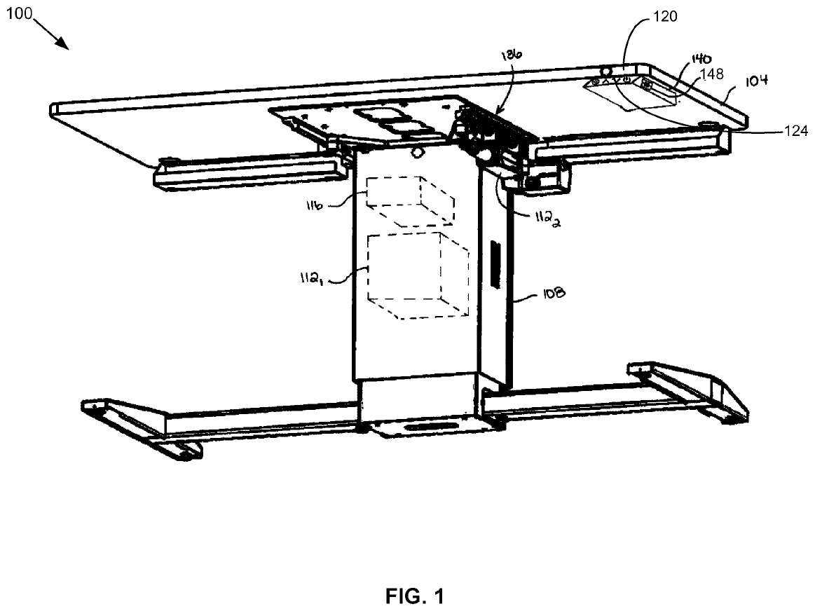

FIG. 1 shows an example power-actuated workstation 100. As shown, workstation 100 includes a tabletop 104 and a vertical support 108. Tabletop 104 may provide a user work surface, such as to support documents, a computer, computer monitor(s), or other user articles. Vertical support 108 may support tabletop 104 above the ground at an elevation which is convenient for the user to interact with the user articles on tabletop 104.

As used herein and in the claims, the “ground” is a common surface that supports the workstation and any users at the workstation. The ground may be an indoor or outdoor floor covering (e.g. hardwood flooring, tiles, carpet, concrete, patio stones, or gravel), or a natural uncovered surface (e.g. grass, or soil).

Workstation 100 may include one or more actuators 112 that are operable to move tabletop 104 (e.g. linearly, rotationally, or arcuately) relative to the ground. In the example shown, workstation 100 includes a vertical actuator 112₁ that is operable to change the vertical position (i.e. elevation) of tabletop 104 above the ground, and a horizontal actuator 112₂ that is operable to change the horizontal position of tabletop 104 over the ground.

Activation of actuator(s) 112 may be controlled by a drive controller 116. Drive controller 116 may activate actuator(s) 112 (e.g. power actuator(s) 112 to execute a movement) in response to signals from user operable controls 120. For example, user operable controls 120 may include directional buttons 124 that a user can press to signal the drive controller 116 to activate the actuator(s) 112 responsible for moving tabletop 104 in the selected direction (e.g. up, down, in, or out). That is, user operable controls 120 may send control signals to drive controller 116, and in response, drive controller 116 may activate actuator(s) 112 in accordance with the control signals. In the example shown, user operable controls 120 are provided on a control unit 140 that is mounted below tabletop 104. However, it will be appreciated that user operable controls 120 may be alternatively located in any user accessible location. For example, control unit 140 may be seated on tabletop 104 without being rigidly mounted. Alternatively, user operable controls 120 may be integrated within a component of workstation (e.g. tabletop 104 or vertical support 108).

An actuator 112 can be any device suitable to move tabletop 104 relative to the ground when activated by drive controller 116. An actuator 112 may include an electrically powered or electrically activated prime mover (i.e. source of motive power). For example, actuator 112 may include an electric motor (e.g. to drive a linear actuator, such as a leadscrew actuator), a solenoid (e.g. to provide linear motion directly, or to operate a valve), or a pump (e.g. to move fluid for activating a piston cylinder). Alternatively or in addition, an actuator 112 may be fluidly powered or fluidly activated. For example, actuator 112 may include a hydraulic or pneumatic device (e.g. a piston cylinder). Optionally, actuator 112 may include a mechanical transmission which may alter the directional characteristic of the prime mover (e.g. convert rotary to linear movement or vice versa), and/or provide mechanical advantage (e.g. multiply output force or torque). For example, actuator 112 may include one or more of gears, belts, screws, bar linkages, racks, or levers.

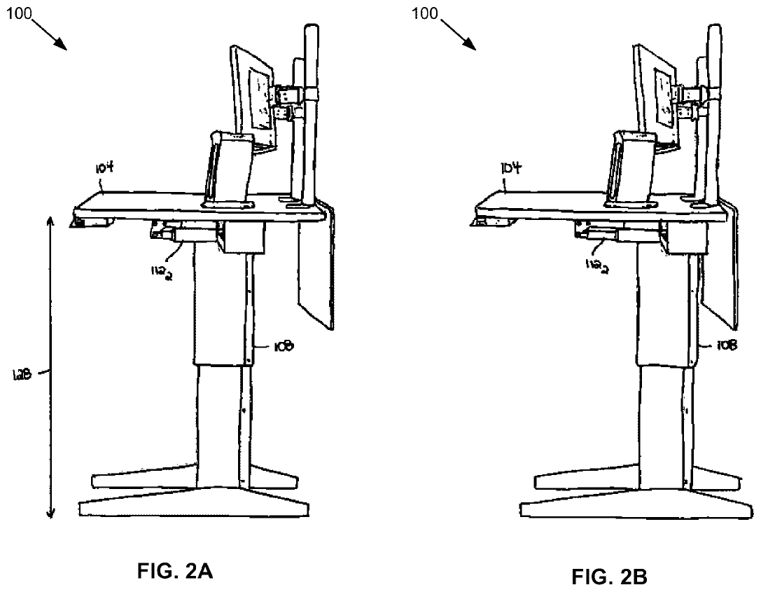

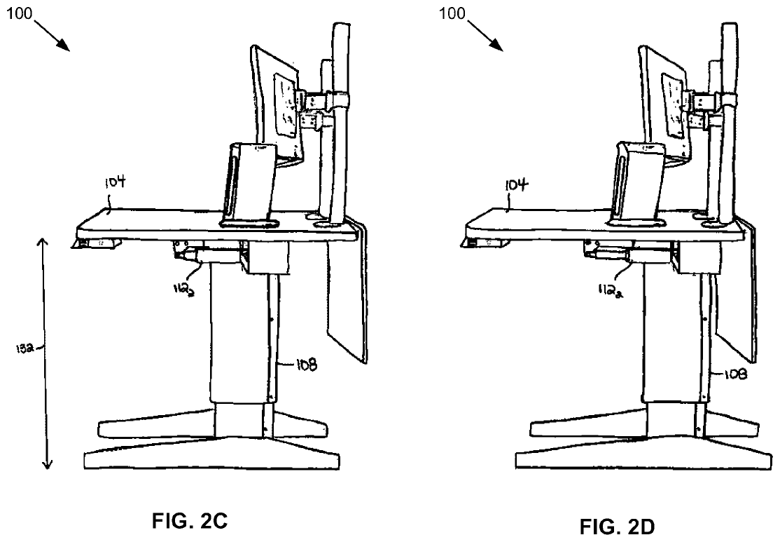

Reference is now made to FIGS. 2A-2D, which show tabletop 104 moved to different positions by actuators 112 (FIG. 1). In the example shown, vertical actuator 112₁ (FIG. 1) is part of vertical support 108 and acts to extend and retract vertical support 108. For example, vertical actuator 112₁ may be operable to extend/retract vertical support 108 between a raised height (FIGS. 2A-2B, e.g. standing height) and a lowered height (FIGS. 2C-2D, e.g. sitting height). Depending on the application of workstation 100 (e.g. as an office desk for computer and paperwork), tabletop 104 may have a raised height 128 of between 0.9 m and 1.5 m for use by a standing user, and a lowered height 132 of between 0.5 m and 0.8 m for use by a seated user. In some cases, vertical actuator 112₁ (FIG. 1) can be stopped at many or every height between the raised and lowered heights. This allows workstation 100 to accommodate users of different body heights, and to accommodate different user postures (e.g. an upright posture when typing, or a leaning posture when drawing or handwriting).

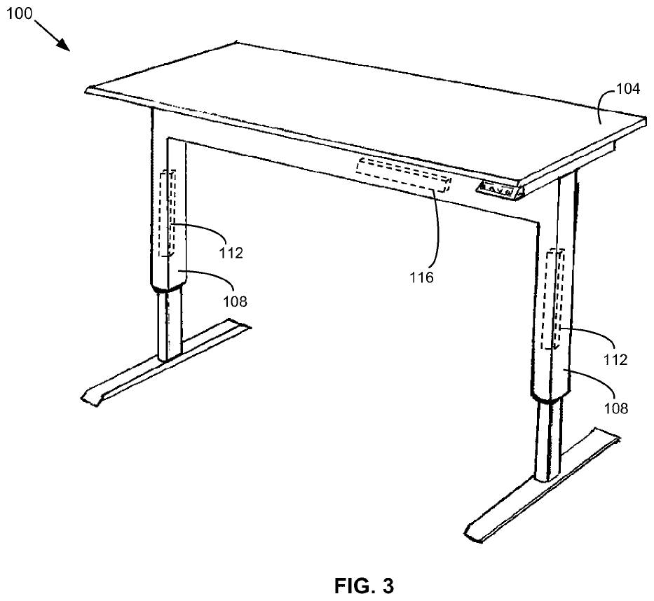

Horizontal actuator 112₂ may form part of the connection between tabletop 104 and vertical support 108. For example, horizontal actuator 112₂ may be operable to move tabletop 104 relative to the ground and vertical support 108 in a direction towards or away from a user position. As shown, this allows horizontal actuator 112₂ to move tabletop 104 between a rearward position (FIGS. 2A and 3A) and a forward position (FIGS. 2B and 3B). In the example shown, tabletop 104 is mounted to vertical support 108 by a rail assembly 136 (FIG. 1), and horizontal actuator 112₂ is a linear actuator (e.g. motorized leadscrew or rack and pinion) that moves tabletop 104 along the rail assembly 136 between the rearward position (FIGS. 2A and 2C) and the forward position (FIGS. 2B and 2D).

In some embodiments, there may be multiple actuators 112 that operate simultaneously or in succession to move tabletop 104 in one direction (e.g. along a linear, rotary, or curved path). For example, workstation 100 may include two or more spaced apart vertical supports 108 to provide greater stability in the case of a large tabletop 104, each vertical support 108 may include a vertical actuator 112₁ (FIG. 1), and all of the vertical actuators 112₁ (FIG. 1) may be activated simultaneously to move tabletop 104 between raised and lowered positions. As an example, FIG. 3 shows a power-actuated workstation 100 that includes two spaced apart vertical supports 108. As shown, each vertical support 108 has its own vertical actuator 112. In response to signals from user operable controls 120, drive controller 116 may activate both vertical actuators 112 simultaneously to move tabletop 104 between raised and lowered positions.

Over the course of a workstation's lifetime, there may be instances in which its drive controller(s) 116 become non-responsive to signals received from user operable controls 120. Accordingly, in these instances, the workstation's user will be unable to raise or lower tabletop 104. Drive controller 116 may fail to respond for a number of reasons. For example, actuator(s) 112 may be over-used. Alternatively, actuator(s) 112 may be obstructed. Alternatively, actuator(s) may not be receiving power. As used herein and in the claims, the term “error” means any error, malfunction, issue and/or event that impairs or prevents normal operation of drive controller 116. Errors that require user intervention for their resolution may last indefinitely if no user intervention (i.e. fix) is provided. In other cases, an error may resolve over time without, or with minimal, user intervention. Two examples of potential errors are provided below for illustrative purposes only. These examples are not exhaustive.

### Example Error 1

Drive controller 116 of workstation 100 may have one or more built-in protection protocols to prevent damage to workstation components. For example, if actuator 112 includes an electric motor, it may burn out if it continues to be powered while an obstruction prevents movement of actuator 112 and/or tabletop 104. To protect against motor burnout, drive controller 116 may automatically cut power to a motor if it is receiving current beyond a predetermined safety threshold. This may be referred to as motor overcurrent protection. Accordingly, during occurrence of such an error, drive controller 116 may be non-responsive to signals received from user operable controls 120. Over time, the current at the motor may drop below the predetermined safety threshold and motor overcurrent protection may be lifted. However, this error may occur again if the workstation's user does not remove the obstruction. With such an error, it will be appreciated that replacement of the entire workstation 100, let alone a service call with a technician, may be unnecessary.

### Example Error 2

Returning to FIG. 3, spaced apart vertical supports 108 may become unbalanced due to unequal activation of their respective actuators 112. It will be appreciated that continuing to operate actuators 112 in such an unbalanced condition may lead to irreparable damage (e.g. bent cylinders, ruptured bearings, etc.). To protect against actuator damage, drive controller 116 may automatically cut power to both vertical actuators 112 if an actuator offset beyond a predetermined safety threshold is detected. This may be referred to as unbalanced protection. Accordingly, during occurrence of such an error, drive controller 116 may be non-responsive to signals received from user operable controls 120. To resolve this error, the actuator offset may need to be reduced below the predetermined safety threshold. Without independent control of each actuator 112, the workstation's user may be unable to resolve such an error.

In many cases, the workstation's user may be unaware of the reason for the lack of response to their inputs on user operable controls 120. For example, drive controller 116 simply may lack the capability of communicating this type of information to the workstation's user. In other cases, drive controller 116 may have the capability of notifying the user when an error has occurred (e.g., with an auditory or visual signal); however, the user may be unable to interpret such a notification. In either case, the user may believe that their workstation 100 is broken and in need of repair and/or replacement. Accordingly, this may prompt the user to initiate a return of workstation 100 to its distributor or manufacturer. Returning such a large piece of equipment generally comes with a number of physical challenges, logistical concerns, and/or elevated transportation costs. Further, the expense of replacing the entire workstation 100 can be a financial strain on the distributor, the manufacturer, the user, or a combination thereof, according to the terms and conditions of the workstation's warranty.

In some cases, the non-responsiveness of drive controller 116 to signals received from user operable controls 120 may prompt the user to schedule a service call with a technician. If, during the service call, the technician is unable to resolve the error and return workstation 100 to normal operation, the user or technician may then initiate a return of workstation 100. In either case, service calls and returns generally lead to user dissatisfaction and significant expenditures of both time and money.

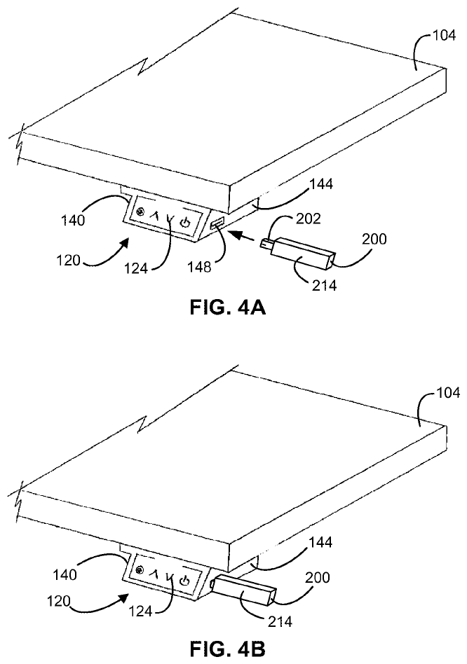

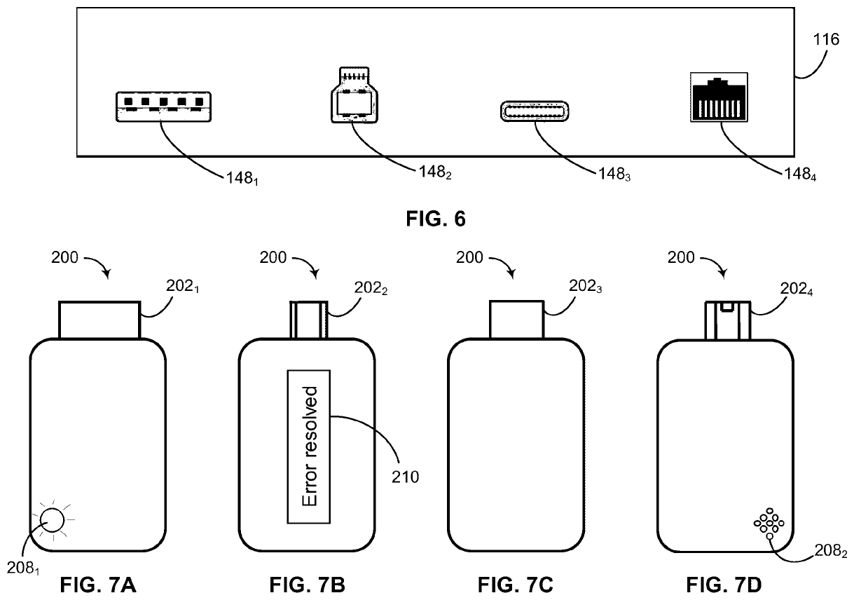

FIGS. 4A-4B show a portable diagnostic tool 200 in accordance with an embodiment. As will be described below, diagnostic tool 200 may be communicatively connected to drive controller 116 (e.g. FIG. 1 or FIG. 3) in order to facilitate resolution of one or more errors impairing normal operation of workstation 100. As shown, diagnostic tool 200 includes a physical data port 202 that is removably connectable to a corresponding physical drive controller data port 148. Drive controller data port 148 is communicatively coupled (e.g. by wire or wirelessly) to drive controller 116 (FIGS. 1 and 3). Therefore, while data port 202 and drive controller data port 148 are physically connected, signals may be transmitted between drive controller 116 and diagnostic tool 200. In the example shown, drive controller data port 148 is located in a sidewall 144 of control unit 140. However, it will be appreciated that drive controller data port 148 may be alternatively located in any user accessible location. For example, as shown in FIG. 6, the drive controller data port 148 is located in a sidewall of the drive controller 116 itself.

Diagnostic tool 200 may be provided as an “add-on” to pre-existing workstations 100 (FIGS. 1-3). As an example, diagnostic tools 200 may be sold to users of workstations 100 as a tool for resolving errors that may affect operation of their workstation 100. As another example, the workstation's manufacturer or distributor may send a diagnostic tool 200 to a user of workstation 100 with a non-responsive drive controller 116 (i.e. a drive controller 116 that will not respond to signals received from user operable controls 120). In either case, the use of diagnostic tool 200 may prevent unnecessary service calls from a technician and/or costly replacements. Further, if the workstation's manufacturer or distributor sends the diagnostic tool 200 with expedited delivery, the user may receive it in as little as a few hours. This may be quicker than scheduling a service call which, depending on availability, may be weeks away.

Alternatively, in some embodiments, diagnostic tool 200 may be an original component of workstation 100. For example, workstation manufacturers may include diagnostic tool 200 as a precaution. In these embodiments, the user may store diagnostic tool 200 in a convenient location, such as a nearby drawer, or taped below tabletop 104, for example, so it is available if ever needed. Alternatively, or in addition, portable diagnostic tool 200 may be provided to technicians who frequently perform service calls related to power-actuated workstations 100.

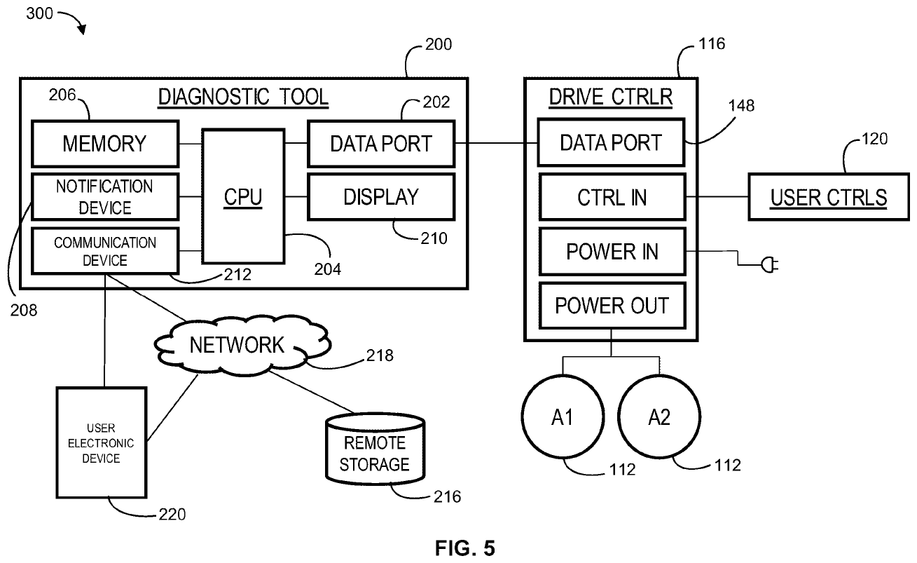

Reference is now made to FIG. 5, which shows a schematic illustration of a workstation diagnostic system 300. Workstation diagnostic system 300 includes one or more drive controllers 116, one or more actuators 112, and a diagnostic tool 200. In the example shown, workstation diagnostic system 300 includes a drive controller 116 drivingly connected to first and second actuators 112. Drive controller 116 and actuators 112 may be physically connected (e.g. by hardwiring) so that drive controller 116 may power corresponding actuators 112 accordingly. In an alternative embodiment, a drive controller 116 may be provided for each actuator 112 (e.g. one drive controller 116 for a vertical actuator 112 and one drive controller 116 for a horizontal actuator 112). In another alternative embodiment, a drive controller 116 may control several actuators 112 (e.g. one drive controller 116 to synchronize several vertical actuators 112, or one drive controller 116 to control both vertical and horizontal actuators 112).

The schematic of FIG. 5 illustrates the connection of user operable controls 120 to drive controller 116. User operable controls 120 may be communicatively coupled to drive controller 116 by wire or wirelessly. As discussed above, user operable controls 120 are manually operable (i.e. operable by deliberate physical interaction with a user's body part, such as a finger) to send command signals to drive controller 116 to activate actuators 112. For example, user operable controls 120 may include one or more of tactile or capacitive buttons 124 (FIG. 4A-4B), switches, sliders, knobs, or touch screens. When activated by the user, user operable controls 120 may signal drive controller 116 and, in response, drive controller 116 may select one or more actuator movements, or a regimen of actuator movements, and operate actuator(s) 112 accordingly.

The schematic of FIG. 5 also illustrates the connection of diagnostic tool 200 to drive controller 116. As described above, diagnostic tool 200 and drive controller 116 are communicatively connected through a physical connection between data port 202 and drive controller data port 148. In the example shown, in addition to data port 202, diagnostic tool 200 also includes a memory 206, notification device 208, display 210, and communication device 212. In some embodiments, diagnostic tool 200 includes multiple of any one or more (or all) of data port 202, processor 204, memory 206, notification device 208, display 210, and communication device 212. In some embodiments, diagnostic tool 200 does not include one or more of notification device 208, display 210, and communication device 212. For example, diagnostic device 200 may not include notification device 208, and/or may not include display 210, and/or may not include communication device 212.

Each of data port 202, memory 206, notification device 208, display 210, and communication device 212 are communicatively coupled to processor 204, directly or indirectly. Preferably, diagnostic tool 200 is a single, unitary device having a housing 214 (FIGS. 4A-4B) that houses all of its subcomponents (processor 204, memory 206, etc.). However, in alternative embodiments, diagnostic tool 200 may be composed of two or more discrete devices that are communicatively coupled to each other, that collectively include all of the subcomponents of diagnostic tool 200 (processor 204, memory 206, etc.), and that collectively provide the functionality described herein.

Referring still to FIG. 5, memory 206 can include volatile memory (e.g. random access memory (RAM)) or non-volatile storage (e.g. ROM, flash memory, hard disk drive, solid state drive, or other types of non-volatile data storage). In some embodiments, memory 206 stores one or more applications for execution by processor 204. The applications correspond with software modules including computer executable instructions to perform processing for the functions and methods described below. In some embodiments, some or all of memory 206 may be integrated with processor 204. For example, processor 204 may be a microcontroller (e.g. Microchip™ AVR, Microchip™ PIC, or ARM™ microcontroller) with onboard volatile and/or non-volatile memory.

Memory 206 may store a plurality of computer readable instruction sets. Each instruction set may be associated with a different drive controller model. For example, memory 206 may store a plurality (e.g. fifty) different computer readable computer instruction sets. Each of these instruction sets may be associated with a specific drive controller model (i.e. fifty drive controller models in total). As will be described below, an instruction set may be identified so that the processor 204 can understand or interpret error signals received from drive controller 112. In effect, the identified instruction set may allow processor 104 to speak the same “language” as drive controller 116.

Memory 206 may also store a plurality of resolutions protocols. Each resolution protocol may be associated with one or more instruction sets. Each resolution protocol may apply to a specific type of error that a corresponding drive controller model may potentially encounter. For example, if a drive controller model has twenty types of errors associated with it, its corresponding instruction set may have twenty associated resolution protocols (i.e. one for each type of error). In some embodiments, a subset of the resolution protocols stored in memory 206 include a firmware update. The firmware updates may replace out-of-date or expired firmware currently running on a drive controller 116. Accordingly, memory 206 of diagnostic tool 200 may contain firmware updates for a number of different drive controller models. In other embodiments, all the resolution protocols stored in memory 206 may include a firmware update. A resolution protocol may be specific to one drive controller model, common to a subset of drive controller models, or common to all drive controller models compatible with the diagnostic tool 200.

Alternatively, or in addition, memory 206 may store a plurality of calibration protocols. Similar to the resolution protocols, each calibration protocol may be associated with one or more instruction sets. Each calibration protocol may apply to a specific drive controller model. For example, if there are thirty known drive controller models, memory 206 may store thirty calibration protocols (i.e. one for each drive controller model). A calibration protocol may be specific to one drive controller model, common to a subset of drive controller models, or common to all drive controller models compatible with the diagnostic tool 200.

Memory 206 may also store a plurality of commands. Each command may be associated with one or more resolution protocols, one or more calibration protocols, or both. As will be described below, one or more commands associated with a selected resolution protocol may be transmitted to drive controller 116 and instruct drive controller 116 to automate that resolution protocol. Once drive controller 116 has automated the resolution protocol, workstation 100 may return to normal operation. That is, drive controller 116 may be responsive to signals received from user operable controls 120. A command may be specific to one resolution protocol, specific to one drive controller model, common to a subset of resolution protocols of the same drive controller model, common to a subset of resolution protocols of two or more drive controller models, or common to all resolution protocols of all drive controller models.

Similarly, one or more commands associated with a selected calibration protocol may be transmitted to drive controller 116 and instruct drive controller 116 to automate that calibration protocol. While drive controller 116 is automating the calibration protocol, diagnostic tool 200 may be able to receive one or more calibration signals from drive controller 116. These calibration signals may contain an assortment of calibration data that may be used by processor 204 of diagnostic tool 200 while it makes decisions. Accordingly, performance of the calibration protocol may be a way for diagnostic tool 200 to calibrate any subsequent information exchanged with drive controller 116 and/or perform an initial assessment of drive controller 116. As will be described below, processor 204 may use such diagnostic data to assess the received error signal and/or customize the one or more commands associated with a selected resolution protocol. A command may be specific to one calibration protocol, specific to one drive controller model, common to a subset of calibration protocols of the same drive controller model, common to a subset of calibration protocols of two or more drive controller models, or common to all calibration protocols of all drive controller models.

Alternatively, or in addition, memory 206 may store a plurality of user directions. Each resolution protocol may have one or more associated user directions. As will be described below, the one or more user directions associated with a selected resolution protocol may be transmitted to a user electronic device 220 and instruct its user how to perform that resolution protocol (e.g. as a list of steps to perform). Once the user has performed the resolution protocol (e.g. completed all steps), workstation 100 may return to normal operation. A user direction may be specific to one resolution protocol, specific to one drive controller model, common to a subset of resolution protocols of the same drive controller model, common to a subset of resolution protocols of two or more drive controller models, or common to all resolution protocols of all drive controller models.

Generally, processor 204 can execute applications, computer readable instructions or programs. The applications, computer readable instructions or programs can be stored in memory 206 or can be received from a remote storage device 216 across wireless access network (WAN) 218 or another suitable IP network (e.g. local access network LAN/storage area (SAN)). When executed, the applications, computer readable instructions or programs can configure the processor 204 (or multiple processors 204, collectively) to perform the acts described herein with reference to drive controller 116 and actuator(s) 112.

Notification device 208 can include any device for communicating user alerts. For example, notification device 208 can be an output device, such as a speaker, or a light emitting device, such as a light emitting diode (LED). As an example, FIG. 7A shows a diagnostic tool 200 that includes an LED 2081 for communicating user alerts. As another example, FIG. 7D shows a diagnostic tool 200 that includes a speaker 2082 for communicating user alerts.

Display 210 can include any type of device for presenting visual information. For example, display 210 can be a display panel. As an example, FIG. 7B shows a diagnostic tool 200 that includes a display panel 210 for presenting visual information.

Returning to FIG. 5, communication device 212 may include one or more of output ports, wireless radios and network adapters (e.g. Bluetooth®, RFID, NFC, 802.11x, etc.) for making wired and wireless connections to user electronic device 220 and/or remote storage device 216. User electronic device 220 may include a smart phone, tablet or notebook computer, for example. Remote storage device 216 may include cloud storage, for example.

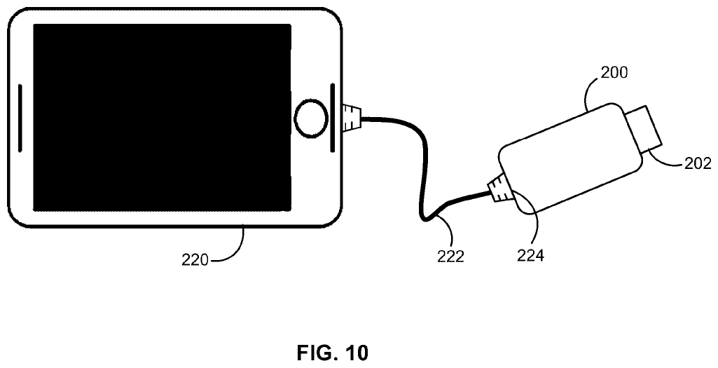

In at least one embodiment, communication device 212 is connectable to a user electronic device 220 across a network, such as WAN 218, for example. Such a connection may allow diagnostic tool 200 to exchange information with user electronic device 220. Alternatively, or in addition, communication device 212 may be connectable to user electronic device 220 through a wired connection. For example, turning to FIG. 10 shows a cable 222 connecting diagnostic tool 200 to a smart phone 220. In the example shown, cable 222 may be disconnected from diagnostic tool 200, at outlet port 224, when not needed. In alternative embodiments, cable 222 may be permanently connected to diagnostic tool 200 to prevent it from being misplaced or lost.

Returning to FIG. 5, in at least one embodiment, communication device 212 is connectable to remote storage device 216 across a network, such as WAN 218 for example. Such a connection may allow diagnostic tool 200 to exchange information with remote storage device 216. As a result, the remote storage device 216 may collect information received from a plurality of diagnostic tools 200 spread across a wide geographic area. This collected information may be analyzed and used to notify one or more manufacturers of a specific type of workstation 100 of the errors most frequently encountered by that workstation 100. In some cases, user electronic device 220 can be independently connected to remote storage 216 across a network, e.g. WAN 218. In these cases, diagnostic tool 200 can be indirectly connected to remote storage device 216 through user electronic device 220. For example, diagnostic tool 200 may be physically connected to user electronic device 220 (FIG. 10) and the user electronic device 220 may be wirelessly connected to remote storage device 216. Such a connection may allow diagnostic tool 200 to exchange information with remote storage device 216 via user electronic device 220.

Data port 202 can be any type of physical output port for exchanging information between processor 204 and drive controller 116 of workstation 100. The connection between data port 202 and drive controller data port 148 can permit processor 204 to send commands to drive controller 116 that operate the actuator(s) 112.

Workstations 100 may include one or multiple physical data ports 148 of the same or different type. For example, FIG. 6 shows an example drive controller 116 of a power-actuated workstation having four different types of drive controller data port 148 located on one of its sidewalls. Drive controller data port 1481 is a “Type A” universal serial bus (USB) port (also referred to as a USB-A port). Drive controller data port 1482 is a “Type B” USB port (also referred to as a USB-B port). Drive controller data port 1483 is a “Type C” USB port (also referred to as a USB-C port). Drive controller data port 1484 is a registered jack (RJ).

Since the number and type of available drive controller data ports 148 may vary across workstations 100, diagnostic tools 200 may be available with different types of data ports 202. As an example, FIGS. 7A-7D each show a diagnostic tool 200 having a different type of data port 202. Referring to FIG. 7A, data port 2021 is a USB-A connector 2021. Accordingly, data port 2021 may mate with drive controller data port 1481 of FIG. 6. Referring to FIG. 7B, data port 2022 is a USB-B connector. Accordingly, data port 2022 may mate with drive controller data port 1482 of FIG. 6. Referring to FIG. 7C, data port 2023 is a USB-C connector. Accordingly, data port 2023 may mate with drive controller data port 1483 of FIG. 6. Referring to FIG. 7D, data port 2024 is a RJ connector. Accordingly, data port 2024 may mate with drive controller data port 1484 of FIG. 6. The different types of drive controller data ports 148 and data ports 202 shown across FIGS. 6-7D are for illustrative purposes and are not intended to be exhaustive.

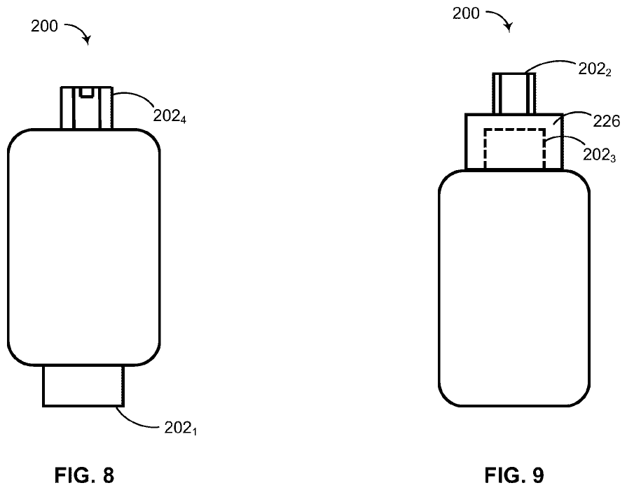

In at least one embodiment, diagnostic tool 200 may include multiple data ports 202 (i.e. 2 or more), each being of a different type. In these embodiments, diagnostic tool 200 may have greater versatility since it may be connected to more than one type of drive controller data port 148. As an example, FIG. 8 shows a diagnostic tool 200 that includes two data ports 2021 and 2024. As shown, data port 2021 (a USB-A connector) and data port 2024 (an RJ connector) extend from opposite ends of diagnostic tool 200. This may allow a user to select the data port 202 (i.e. data port 2021 or data port 2024) that matches the type of drive controller data port 148.

In at least one embodiment, diagnostic tool 200 may include one or more removable data port adapters, each having a different type of adapter data port. For example, a data port adapter may be connected to data port 202 of portable diagnostic tool 200 to convert data port 202 into a data port that matches the type of drive controller data port 148. Alternatively, a data port adapter may be connected to drive controller data port 148 to convert drive controller data port 148 into a data port that matches the type of data port 202 of diagnostic tool 200. As an example, FIG. 9 shows a data port adapter 226 connected to diagnostic tool 200 of FIG. 7C. Data port adapter 226 may be used when drive controller data port 148 is a USB-B port and data port 202 of diagnostic tool is a USB-C connector. As shown, data port adapter 226 has an adapter data port 2022 (a USB-B connector). Thus, when connected, data port adapter 226 converts data port 2023 (a USB-C connector) of diagnostic tool 200 into a USB-B connector. In addition to providing greater versatility, data ports adapters may lower manufacturing costs because they allow a single diagnostic tool 200 to be manufactured which can be adapted (post-manufacturing) so that it can be connected to a number of different types of drive controller data ports 148.

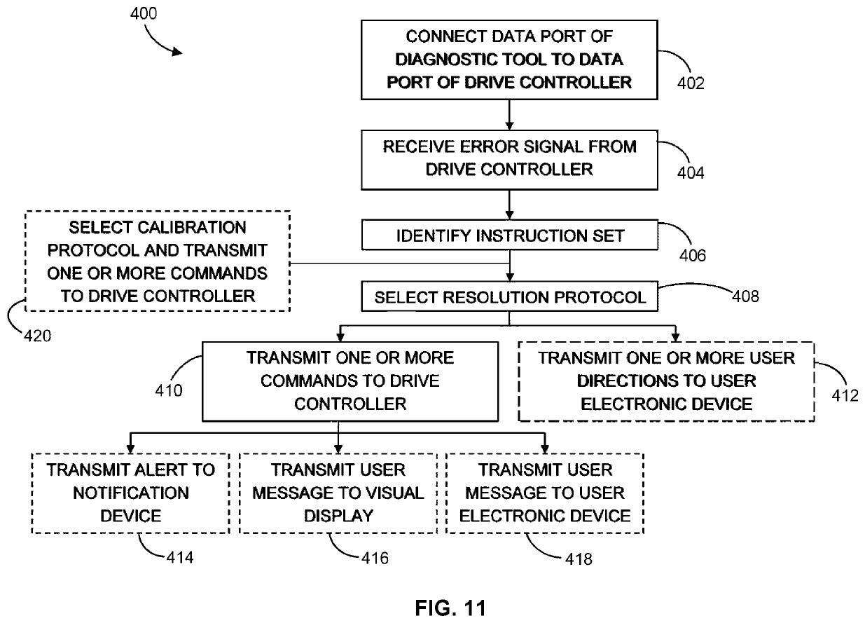

FIG. 11 shows a flowchart illustrating an example method 400 of resolving an error associated with a drive controller of a power-actuated workstation. For clarity of illustration, method 400 is described below with reference to portable diagnostic tool 200. However, method 400 is not limited to the use of diagnostic tool 200, and can be practiced using any suitable device or tool.

At step 402, data port 202 of diagnostic tool 200 is physically connected to drive controller data port 148 (e.g. as shown in FIGS. 4A-4B). For example, the workstation's user or a technician may connect diagnostic tool 200 when an error has impaired, or prevented, normal operation of workstation 100. In this context, normal operation of workstation 100 may be characterized as a condition in which drive controller 116 accurately and promptly responds to signals received from user operable controls 120. As described above, such a connection, at step 402, places diagnostic tool 200 in communication with drive controller 116, thereby enabling two-way communication.

At step 404, processor 204 of diagnostic tool 200 may receive an error signal from drive controller 116. The error signal is generated by drive controller 112 and may include information related the outstanding error (e.g. type, part effected, duration, etc.). In some cases, the received error signal may allow processor 204 of diagnostic tool 200 to determine that firmware of drive controller 116 is out-of-date and/or expired.

At step 406, processor 204 of diagnostic tool 200 may identify one of the plurality of computer readable instruction sets stored in memory 206. The identified instruction set corresponds to the drive controller model that matches drive controller 116. The instruction set identified at step 406 can enable processor 204 to understand (i.e. interpret) error signals received from drive controller 112. In effect, the identified instruction set may allow processor 104 to speak the same “language” as drive controller 116. Steps 404 and 406 may be performed in any order, or simultaneously.

In some embodiments, processor 204 may identify the model of the drive controller (e.g. particular model of a particular brand of drive controller) and/or the computer readable instruction set matching the model of the drive controller based on data exchanged between diagnostic tool 200 (e.g. processor 204) and drive controller 116 at the time diagnostic tool 200 is communicatively coupled (e.g. physically connected) to drive controller 116. For example, diagnostic tool 200 and drive controller 116 may engage in a handshake, as prescribed by the standards protocol of their data connection (e.g. a USB 2.0 or USB 3.0 protocol handshake). Alternatively or in addition, processor 204 may exchange other communication signals with drive controller 116 to identify the model of the drive controller and/or the computer readable instruction set matching the model of the drive controller. In some cases, the communication signals exchanged between drive controller 116 and diagnostic tool 200 (e.g. during the handshake at step 406) may allow processor 204 of diagnostic tool 200 to determine that firmware of drive controller 116 is out-of-date and/or expired. In other cases, i) the communication signals exchanged between the drive controller 116 (at step 406) and the diagnostic tool 200 and ii) the received error signal (at step 404) may allow processor 204 of diagnostic tool 200 to determine that firmware of drive controller 116 is out of date and/or expired.

In some cases, at step 406, processor 204 may determine that each of the plurality of instruction sets stored in memory 206 fail to correspond to the drive controller model that matches drive controller 116. For example, at the time diagnostic tool 200 was distributed, an instruction set corresponding to the drive controller model that matches drive controller 116 may not have been stored in memory 206. In these cases, in order to identify an instruction set corresponding to the drive controller model that matches the drive controller 116, processor 204 may retrieve a computer readable instruction set from remote storage device 216. In this context, instruction sets stored in memory 206 may be referred to as “local” instruction sets, while instruction sets stored in remote storage device 216 may be referred to as “remote” instruction sets. Remote instruction sets may perform the same function as local instruction sets.

At step 408, processor 204 of diagnostic tool 200 may select one of the plurality of resolution protocols associated with the selected instruction set (local or remote). Processor 204 may select the resolution protocol based on the identified instruction set (at step 406) and the received error signal (at step 404). Effectively, at step 408, processor 204 may select the resolution protocol suited to resolving the outstanding error from among the plurality of resolution protocols associated with the drive controller model that matches drive controller 116. As described above, processor 204 may determine that firmware of drive controller 116 is out-of-date and/or expired. In these cases, the resolution protocol selected at step 408 may include a firmware update for drive controller 116.

As described above, each resolution protocol may be associated with one or more user commands, one or more user directions, or a combination thereof. For example, one resolution protocol may be associated with only commands, while another resolution protocol may be associated with only user directions. Still another resolution protocol may be associated with a combination of commands and user instructions. The composition of each resolution protocol may depend on the nature of the error to be resolved. For example, some errors may require user interventions (e.g. removing an obstruction) while the resolution of other errors may be fully automated without user intervention (e.g. leveling first and second vertical actuators).

In some cases, at step 408, processor 204 may determine that each of the plurality of resolution protocols stored in memory 206 are inappropriate for selection based on the received error signal and the identified instruction set. For example, at the time diagnostic tool 200 was distributed, a resolution protocol for the outstanding error may not have been stored in memory 206. In these cases, in order to select a resolution protocol based on the received error signal and the identified instruction set, processor 204 may retrieve a resolution protocol from remote storage device 216. In this context, resolution protocols stored in memory 206 may be referred to as “local” resolution protocols, while resolution protocols stored in remote storage device 216 may be referred to as “remote” resolution protocols. Remote resolution protocols may perform the same function as local resolution protocols.

At step 410, processor 204 of diagnostic tool 200 may transmit the one or more commands associated with the selected resolution protocol to drive controller 116. The one or more commands may instruct drive controller 116 to automate the selected resolution protocol (from step 408). Once automation of the selected resolution protocol is complete, operation of workstation 100 may return to normal. In some cases, the one or more commands instruct drive controller 116 to reset, or to turn off and then back on. For example, the one more commands may instruct drive controller 116 to turn off and then turn back on after a cooling off period (e.g. at least 30 seconds, such as for example a cooling off period of 30 seconds to 30 minutes, or 30 seconds to 5 minutes, etc.). In other cases, the one or more commands instruct drive controller 116 to operate actuator(s) 112 according to the selected resolution protocol. For example, the one or more commands transmitted to drive controller 116 may instruct drive controller 116 to:
(i) move actuator(s) 112 to a home position (or reset position),
(ii) reverse a movement direction of the actuator(s) 112, and/or
(iii) move a first vertical actuator 112 an offset distance relative to a second vertical actuator 112 to level the first and second vertical actuators.

As a more specific example, the commands may instruct drive controller 116 to move a first vertical actuator 112 down 2 cm so that it is level with a second vertical actuator 112. In the cases where the resolution protocol selected at step 408 includes a firmware update for drive controller 116, the one or more commands transmitted to drive controller 116 may instruct drive controller 116 to install and/or run the firmware update, for example.

In some embodiments, the one or more commands may be transmitted to drive controller 116 in response to receiving a user approval. That is, the user of workstation 100 may need to approve the transmission of the one or more commands to drive controller 116 before they are actually transmitted at step 412. For example, the user may be using workstation 100 to perform a time sensitive task which may be disrupted in the event the resolution protocol involves instructing movement of actuator(s) 112. Accordingly, it may be preferable for such user to give their approval before the one or more commands are transmitted to drive controller 116. In some embodiments, the user may approve or reject the transmission of the commands to drive controller 116 at step 412 through user electronic device 220, diagnostic tool 200, or both. For example, the user electronic device 200 may prompt the user to either approve or reject the transmission, and a transmission based on the user's input (to approve or reject) may be sent to the diagnostic tool 200. Diagnostic tool 200 may perform the associated one or more commands for which approval was sought only upon receiving a transmission indicative of the user's approval.

In some cases, remote storage device 216 may store a plurality of commands. Each command may be associated with one or more resolution protocols. For example, at step 210, one or more commands may be retrieved from remote storage device 218 when memory 206 does not store all commands associated with the selected resolution protocol. In this context, commands stored in memory 206 may be referred to as “local” commands, while commands stored in remote storage device 216 may be referred to as “remote” commands. Remote commands may perform the same function as local commands.

At step 412, processor 204 of diagnostic tool 200 may transmit the one or more user directions associated with the selected resolution protocol (from step 408) to user electronic device 220. The user directions may instruct the user on how to perform the selected resolution protocol. For example, the user directions may be shown on the display of user electronic device 220. The user directions may be sent via a text message (SMS) to user electronic device 220. In cases where user electronic device 220 operates a software application or web-based application that is associated with diagnostic tool 200, the user directions may be viewable via the application. In other cases, processor 204 of diagnostic tool 200 may transmit the one or more user directions via email. Once the user has performed the user directions of the selected resolution protocol, operation of workstation 100 may return to normal.

If the selected resolution protocol is associated with a combination of one or commands and one or more user directions, method 400 may include both steps 410 and 412. For example, the one or more commands may instruct drive controller 116 to automate a first portion of the selected resolution protocol, while the one or more user directions may instruct the user to perform a second portion of the selected resolution protocol. Once automation of the first portion of the selected resolution protocol is complete and the user has performed the second portion of the selected resolution protocol, operation of workstation 100 may return to normal.

At step 414, processor 204 of diagnostic tool 200 may transmit one or more user alerts to notification device 208 in response to one or more of:
(i) receiving the error signal from drive controller 116 (step 404),
(ii) identifying the one of the plurality of instruction sets (step 406),
(iii) determining the corresponding one of the plurality of resolution protocols (step 408),
(iv) transmitting the one or more commands to drive controller 116 (step 410), and
(v) transmitting the one or more user directions to user electronic device 220 (step 412).

For simplicity of illustration, step 414 is only shown in response to step 410 (i.e. in response to transmitting the one or more commands to drive controller 116)—i.e. example (iv) above.

In some cases, remote storage device 216 may store a plurality of user directions. Each user direction may associated with one or more resolution protocols. For example, at step 212, one or more user directions may be retrieved from remote storage device 218 when memory 206 does not store all user directions associated with the selected resolution protocol. In this context, user directions stored in memory 206 may be referred to as “local” user directions, while user directions stored in remote storage device 216 may be referred to as “remote” user directions. Remote user directions may perform the same function as local user directions.

As described above, notification device 208 may be a speaker (speaker 2082 of FIG. 7D) and/or a light emitting device (e.g. LED 2081 of FIG. 7A), for example. The user alert may be an auditory signal (when notification device 208 is a speaker), and/or a visual signal (when notification device 208 is a light emitting device). The user alert may communicate a resolution status to the user or another type of warning or alert. For example, flashing of LED 2081 may indicate that automation of the selected resolution protocol is in progress. Alternatively, a “beep” sound from speaker 2082 may indicate that processor 204 has identified an instruction set that corresponds to the drive controller model that matches drive controller 116.

At step 416, processor 204 of diagnostic tool 200 may transmit one or more user messages to display 210 in response to one or more of:
(i) receiving the error signal from drive controller 116 (step 404),
(ii) identifying the one of the plurality of instruction sets (step 406),
(iii) determining the corresponding one of the plurality of resolution protocols (step 408),
(iv) transmitting the one or more commands to drive controller 116 (step 410), and
(v) transmitting the one or more user directions to user electronic device 220 (step 412).

For simplicity of illustration, step 416 is only shown in response to step 410 (i.e. in response to transmitting the one or more commands to drive controller 116)—i.e. example (iv) above.

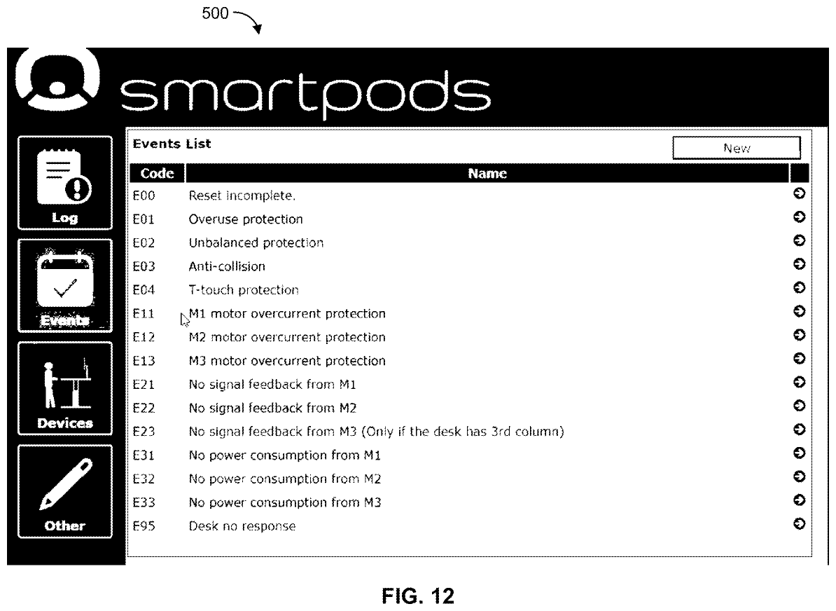

As described above, display 210 may be a display panel, for example. Accordingly, the user message may be text and/or a symbol shown on display 210 (e.g. display panel 210 on FIG. 7B). Similar to user alerts, user messages may communicate a resolution status (e.g. “in progress”, “resolution protocol found”, “error resolved”, etc.) to the user or another type of warning or alert. Alternatively, or in addition, in response to receiving the error signal from drive controller 116 (step 404), the user message may include an error interpretation of the received error signal. For example, the error interpretation may help the user assess the error (e.g. its type, location, severity, etc.). The error interpretation may be an error code that the user can look up in their workstation user manual. As an example, FIG. 12 shows a screenshot 500 of an error list that may be consulted to assess the error. Alternatively, or in addition, the error interpretation may communicate the type or class of error, e.g. “unbalanced supports”, “obstruction”, etc.).

At step 418, processor 204 of diagnostic tool 200 may transmit one or more user device messages to user electronic device 220 in response to one or more of:
(i) receiving the error signal from drive controller 116 (step 404),
(ii) identifying the one of the plurality of instruction sets (step 406),
(iii) determining the corresponding one of the plurality of resolution protocols (step 408),
(iv) transmitting the one or more commands to drive controller 116 (step 410), and
(v) transmitting the one or more user directions to user electronic device 220 (step 412).

For simplicity of illustration, step 418 is only shown in response to step 410 (i.e. in response to transmitting the one or more commands to drive controller 116).

User electronic device 220 may be a smart phone, tablet, or notebook computer, for example. In some instances, user electronic devices 220 may operate a software application or web-based application that is associated with or otherwise linked to diagnostic tool 200. Considering the size and resolution of the displays of user electronic device 220 relative to display 210 of diagnostic tool 200 (e.g. FIG. 7B), user device messages are able to contain more detailed information than user messages.

User device messages may be text and/or a symbol that is shown on the display of user electronic device 220. Similar to user alerts and user messages, user device messages may communicate a resolution status (e.g. “in progress”, “resolution protocol found”, “error resolved”, etc.) to the user or another type of warning or alert. Alternatively, or in addition, in response to receiving the error signal from drive controller 116 (step 404), the user message may include an error report for the received error signal. As example, the error report may communicate the type or class of error, part(s) effected, time stamp, duration, e.g. “Code: E03; Name: Obstruction at left actuator; Duration: 2 hrs.”

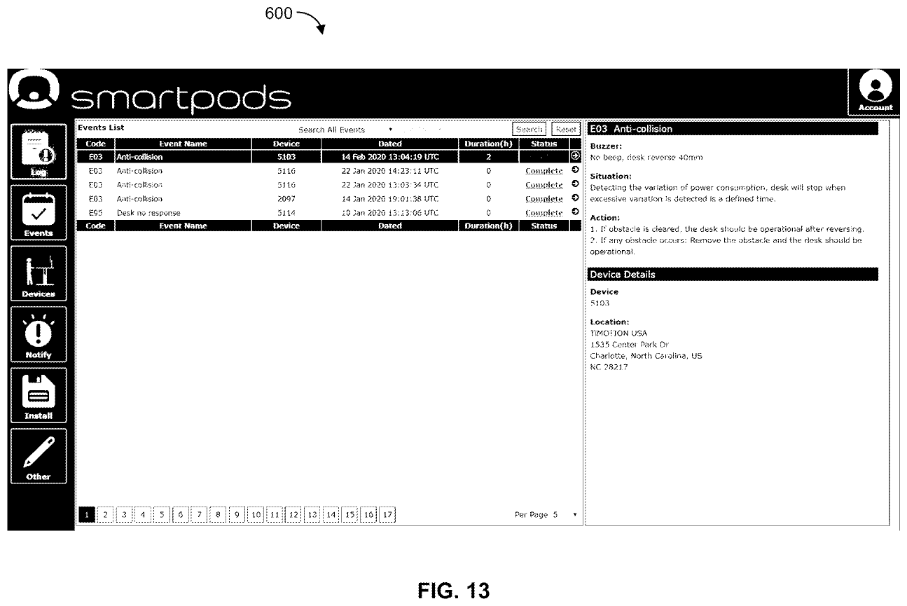

Alternatively, or in addition, the user device message may include an events log. The events log may communicate the status of the error (e.g. resolved, pending, etc.) and/or log the history of errors associated with drive controller 116. As an example, FIG. 13 shows a screenshot 600 of an events log that may be shown on the display of a user electronic device 220.

At step 420, processor 204 of diagnostic tool 200 may select a corresponding one of the plurality of calibration protocols based on the identified instruction set and then transmit, to the drive controller, the one or more commands associated with the selected calibration protocol that instruct the drive controller to automate the selected calibration protocol. As described above, while drive controller 116 is automating the selected calibration protocol, processor 204 may be further configured to receive one or more calibration signals from drive controller 116. These calibration signals may include various calibration results, such as, for example, motor speeds, max/min heights and motor currents. In this way, diagnostic tool 200 may be able to gather calibration data from drive controller 116 that processor 204 may then use to adapt (i.e. modify, customize, calibrate, tailor, etc.) the manner in which it resolves errors encountered by drive controller 116. For example, processor 204 may use such calibration data to better assess the received error signal (at step 404), select a corresponding resolution protocol (at step 408) and/or tailor the one or more commands transmitted to drive controller 116 (at step 410). Step 420 is preferably performed prior to step 404, step 408 or step 410. More preferably, step 420 is performed before steps 408 and 410.

For example, the one or more commands transmitted to drive controller 116 at step 420 may instruct drive controller 116 to:

(i) raise actuator(s) 112 to determine at least one of a maximum height, an against-gravity motor speed, and a raising motor current, and

(ii) lower actuator(s) 112 to determine at least one of a minimum height, a gravity-aided motor speed, and a lowering motor current.

The calibration signals sent to processor 204 (from drive controller 116) during (or after automation) of the selected calibration protocol may include one or more of the maximum and minimum heights, the against-gravity and gravity-aided motor speeds, and the raising and lowering motor currents. Accordingly, processor 204 of diagnostic tool 200 may take one or more of the maximum and minimum heights, the against-gravity and gravity-aided motor speeds, and the raising and lowering motor currents into consideration while interpreting the error signal received at step 404, selecting the corresponding resolution protocol at step 408 and/or determining which commands associated with the selected resolution protocol to transmit to drive controller 116 at step 410. In this context, performance of selected calibration protocol calibrates diagnostic tool 200 to drive controller 116. This may allow diagnostic tool 200 to provide a calibrated or customized resolution to errors encountered by drive controller 116.

Diagnostic tool 200 and method 400 may reduce the amount of costly and labour intensive returns as well as the amount of service calls from technicians. In turn, this may lessen the financial strain placed on users, distributors and/or manufacturers, the physical and logistical challenges of returning workstations 100, and/or the duration for which the user may be without an operable workstation 100. In some cases, performance of method 400 may not lead to a resolution of the outstanding error. In these cases, it now may be appropriate for a user to initiate a return of workstation 100 or set a service call from a technician. At least now the distributor and/or manufacturer can be assured that the error is of the type or severity that warrants a service call from a technician or a replacement workstation 100.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A portable diagnostic tool for a drive controller of a power-actuated workstation, the drive controller operating at least one workstation actuator, the portable diagnostic tool comprising:
one or more processors;
a memory communicatively coupled to at least one of the processors, the memory storing a plurality of computer readable instruction sets, each instruction set being associated with a different drive controller model of a plurality of drive controller models, each instruction set being associated with a plurality of resolution protocols, each resolution protocol being associated with one or more commands; and
at least one physical data port communicatively coupled to at least one of the processors, the at least one physical data port being removably connectable to a corresponding physical drive controller data port,
wherein, while the portable diagnostic tool is communicatively connected to the drive controller, the one or more processors are configured to collectively:
receive an error signal from the drive controller;
identify one of the plurality of instruction sets corresponding to the drive controller model of the plurality of drive controller models that matches the drive controller;
select a corresponding one of the plurality of resolution protocols based on the identified instruction set and the received error signal; and
transmit, to the drive controller, the one or more commands associated with the selected resolution protocol instructing the drive controller to automate the selected resolution protocol.
   Item 2: The portable diagnostic tool of any other item, wherein:
   the one or more commands transmitted to the drive controller are transmitted in response to receiving a user approval.
   Item 3: The portable diagnostic tool of any other item, wherein: the selected resolution protocol comprises a firmware update for the drive controller.
   Item 4: The portable diagnostic tool of any other item, wherein:
   the at least one physical data port comprises at least one of a universal serial bus (USB) connector and a registered jack (RJ) connector.
   Item 5: The portable diagnostic tool of any other item, wherein:
   the one or more commands transmitted to the drive controller instruct the drive controller to operate the at least one workstation actuator according to the selected resolution protocol.
   Item 6: The portable diagnostic tool of any other item, wherein:
   the one or more commands transmitted to the drive controller instruct the drive controller to (i) move the at least one workstation actuator to a home position, (ii) reverse a movement direction of the at least one workstation actuator, (iii) reset the drive controller, or (iv) turn the drive controller off and then back on.
   Item 7: The portable diagnostic tool of any other item, wherein:

the one or more processors are configured to collectively:
select a corresponding one of a plurality of calibration protocols based on the identified instruction set; and
transmit, to the drive controller, one or more commands associated with selected calibration protocol instructing the drive controller to automate the selected calibration protocol,
receive, from the drive controller, one or more calibration signals that comprise calibration data,
   wherein the selected resolution protocol is calibrated based on the received calibration data.
      Item 8: The portable diagnostic tool of any other item, further comprising:
      a notification device communicatively coupled to at least one of the processors, and wherein, while the portable diagnostic tool is communicatively connected to the drive controller, the one or more processors are further configured to collectively:
transmit one or more user alerts to the notification device in response to one or more of (i) receiving the error signal from the drive controller, (ii) identifying the one of the plurality of instruction sets, (iii) selecting the corresponding one of the plurality of resolution protocols, and (iv) transmitting the one or more commands to the drive controller.
   Item 9: The portable diagnostic tool of any other item, wherein:
   the one or more user alerts comprise at least one of an auditory alert and a visual alert.
   Item 10: The portable diagnostic tool of any other item, further comprising:
   a visual display communicatively coupled to at least one of the processors, and wherein, while the portable diagnostic tool is communicatively connected to the drive controller, the one or more processors are further configured to collectively:
transmit one or more user messages to the visual display in response to one or more of (i) receiving the error signal from the drive controller, (ii) identifying the one of the plurality of instruction sets, (iii) selecting the corresponding one of the plurality of resolution protocols, and (iv) transmitting the one or more commands to the drive controller.
   Item 11: The portable diagnostic tool of any other item, wherein:
   the one of more messages transmitted to the visual display comprise an error interpretation of the received error signal.
   Item 12: The portable diagnostic tool of any other item, further comprising:
   a user communication device communicatively coupled to at least one of the processors, the portable diagnostic tool being communicatively connectable to a user electronic device by way of the user communication device, and wherein, while the portable diagnostic tool is communicatively connected to the drive controller and the user electronic device, the one or more processors are further configured to collectively:
transmit one or more user device messages to the user electronic device in response to one or more of (i) receiving the error signal from the drive controller, (ii) identifying the one of the plurality of instruction sets, (iii) selecting the corresponding one of the plurality of resolution protocols, and (iv) transmitting the one or more commands to the drive controller.
   Item 13: The portable diagnostic tool of any other item, wherein:
   in response to receiving the error signal from the drive controller, the one of more user device messages transmitted to the user electronic device comprise an error report for the received error signal.
   Item 14: The portable diagnostic tool of any other item, wherein:
   in response to transmitting the one or more commands to the drive controller, the one or more user device messages transmitted to the user electronic device comprise an event log.
   Item 15: The portable diagnostic tool of any other item, wherein:
   the at least one workstation actuator comprises a first workstation actuator and a second workstation actuator, and the one or more commands transmitted to the drive controller instruct the drive controller to operate the first workstation actuator and the second workstation actuator according to the selected resolution protocol.
   Item 16: The portable diagnostic tool of any other item, wherein:
   the one or more commands transmitted to the drive controller instruct the drive controller to move one of the first and second workstation actuators an offset distance relative to the other of the first and second workstation actuators to level the first and second workstation actuators.
   Item 17: A portable diagnostic tool for a drive controller of a power-actuated workstation, the drive controller operating at least one workstation actuator, the portable diagnostic tool comprising:
   one or more processors;
   a memory communicatively coupled to at least one of the processors, the memory storing a plurality of computer readable instruction sets, each instruction set being associated with a different drive controller model of a plurality of drive controller models, each instruction set being associated with a plurality of resolution protocols, each resolution protocol being associated with one or more user directions;
   at least one physical data port communicatively coupled to at least one of the processors, the at least one physical data port being removably connectable to a corresponding physical drive controller data port; and
   a user communication device communicatively coupled to at least one of the processors, the user communication device being communicatively connectable to a user electronic device,
   wherein, while the portable diagnostic tool is communicatively connected to the drive controller and the user electronic device, the one or more processors are configured to collectively:
receive an error signal from the drive controller;
identify one of the plurality of instruction sets corresponding to the drive controller model of the plurality of drive controller models that matches the drive controller;
select a corresponding one of the plurality of resolution protocols based on the identified instruction set and the received error signal; and
transmit, to the user electronic device, the one or more user directions associated with the selected resolution protocol to perform the selected resolution protocol.
   Item 18: The portable diagnostic tool of any other item, wherein:
   the user communication device is wirelessly connectable to the user electronic device.
   Item 19: The portable diagnostic tool of any other item, wherein:
   the user communication device is wirelessly connectable to the user electronic device by at least one of wireless fidelity (Wi-Fi), Bluetooth®, radio frequency identification (RFID), near-field communication (NFC) and a mobile network.
   Item 20: The portable diagnostic tool of any other item, wherein:
   the user communication device comprises a USB port.
   Item 21: A portable diagnostic tool for a drive controller of a power-actuated workstation, the drive controller operating at least one workstation actuator, the portable diagnostic tool comprising:
   one or more processors;
   a memory communicatively coupled to at least one of the processors, the memory storing a plurality of computer readable instruction sets, each instruction set being associated with a different drive controller model of a plurality of drive controller models, each instruction set being associated with a plurality of resolution protocols, each resolution protocol being associated with one or more commands and one or more user directions;
   at least one physical data port communicatively coupled to at least one of the processors, the at least one physical data port being removably connectable to a corresponding physical drive controller data port; and
   a user communication device communicatively coupled to at least one of the processors, the user communication device being communicatively connectable to a user electronic device,
   wherein, while the portable diagnostic tool is communicatively connected to the drive controller and the user electronic device, the one or more processors are configured to collectively:
receive an error signal from the drive controller;
identify one of the plurality of instruction sets corresponding to the drive controller model of the plurality of drive controller models that matches the drive controller;
select a corresponding one of the plurality of resolution protocols based on the identified instruction set and the received error signal;
transmit, to the drive controller, the one or more commands associated with the selected resolution protocol instructing the drive controller to automate a first portion of the selected resolution protocol; and
transmit, to the user electronic device, the one or more user directions associated with the selected resolution protocol to perform a second portion of the selected resolution protocol.
   Item 22: The portable diagnostic tool of any other item, wherein:
   the one or more commands transmitted to the drive controller instruct the drive controller to operate the at least one workstation actuator according to the selected resolution protocol.
   Item 23: A portable diagnostic tool for a drive controller of a power-actuated workstation, the drive controller operating at least one workstation actuator, the portable diagnostic tool comprising:
   one or more processors;
   a memory communicatively coupled to at least one of the processors, the memory storing a plurality of computer readable local instruction sets, each local instruction set being associated with a different drive controller model of a plurality of drive controller models, each local instruction set being associated with a plurality of local resolution protocols, each local resolution protocol being associated with one or more local commands;
   at least one physical data port communicatively coupled to at least one of the processors, the at least one physical data port being removably connectable to a corresponding physical drive controller data port; and
   a server communication device communicatively coupled to at least one of the processors, the server communication device being communicatively connectable to a server across a wireless network,
   wherein, while the portable diagnostic tool is communicatively connected to the drive controller and the server, the one or more processors are configured to collectively:
receive an error signal from the drive controller;
retrieve a computer readable remote instruction set from remote network storage, the remote instruction set corresponding to the drive controller model of the plurality of drive controller models that matches the drive controller, the remote instruction set being associated with a plurality of remote resolution protocols, each remote resolution protocol being associated one or more remote commands;
select a corresponding one of the plurality of remote resolution protocols based on the identified remote instruction set and the received error signal; and
transmit, to the drive controller, the one or more commands associated with the selected remote resolution protocol instructing the drive controller to automate the selected remote resolution protocol.
   Item 24: The portable diagnostic tool of any other item, wherein:
   while the portable diagnostic tool is communicatively connected to the drive controller and the server, the one or more processors are further configured to collectively:
prior to identifying the remote instruction set in remote network storage, determine that each of the plurality of local instruction sets fail to correspond to the drive controller model of the plurality of drive controller models that matches the drive controller.
   Item 25: The portable diagnostic tool of any other item, wherein:
   the one or more remote commands transmitted to the drive controller instruct the drive controller to operate the at least one workstation actuator according to the selected remote resolution protocol.
   Item 26: The portable diagnostic tool of any other item, wherein the one or more remote commands transmitted to the drive controller are transmitted in response to receiving a user approval.
   Item 27: The portable diagnostic tool of any other item, wherein the selected remote resolution protocol comprises a firmware update for the drive controller.
   Item 28: A portable diagnostic tool for a drive controller of a power-actuated workstation, the drive controller operating at least one workstation actuator, the portable diagnostic tool comprising:
   one or more processors;
   a memory communicatively coupled to at least one of the processors, the memory storing a plurality of computer readable instruction sets, each instruction set being associated with a different drive controller model of a plurality of drive controller models, each instruction set being associated with a plurality of calibration protocols, each calibration protocol being associated with one or more commands; and
   at least one physical data port communicatively coupled to at least one of the processors, the at least one physical data port being removably connectable to a corresponding physical drive controller data port,
   wherein, while the portable diagnostic tool is communicatively connected to the drive controller, the one or more processors are configured to collectively:
identify one of the plurality of instruction sets corresponding to the drive controller model of the plurality of drive controller models that matches the drive controller;
select a corresponding one of the plurality of calibration protocols based on the identified instruction set; and
transmit, to the drive controller, the one or more commands associated with the selected calibration protocol instructing the drive controller to automate the selected calibration protocol.
   Item 29: The portable diagnostic tool of any other item, wherein:
   the one or more commands transmitted to the drive controller instruct the drive controller to operate the at least one workstation actuator according to the selected calibration protocol.
   Item 30: A method of resolving an error associated with a drive controller of a power-actuated workstation, the drive controller operating at least one workstation actuator, the method comprising:
   communicatively coupling a portable diagnostic tool to the drive controller by connecting a physical data port of the portable diagnostic device to a physical data port of the drive controller, the physical data port of the diagnostic tool being communicatively coupled to one or more processors located within the portable diagnostic tool;
   receiving an error signal from the drive controller at the one or more processors of the portable diagnostic device by way of the physical data port of the portable diagnostic tool;
   identifying a computer readable instruction set from a plurality of computer readable instruction sets stored in a memory of the portable diagnostic device corresponding to a drive controller model of a plurality of drive controller models that matches the drive controller;
   selecting a resolution protocol from a plurality of resolution protocols stored in the memory of the portable diagnostic tool based on the identified instruction set and the received error signal; and
   transmitting to the drive controller, by way of the physical data port of the portable diagnostic tool, one or more commands associated with the selected resolution protocol, wherein the one or more transmitted commands instruct the drive controller to automate the selected resolution protocol.

1. A portable diagnostic tool for a drive controller of a power-actuated workstation, the drive controller operating at least one workstation actuator, the portable diagnostic tool comprising:
one or more processors;
a memory communicatively coupled to at least one of the processors, the memory storing a plurality of computer readable instruction sets, each instruction set being associated with a different drive controller model of a plurality of drive controller models, each instruction set being associated with a plurality of resolution protocols, each resolution protocol being associated with one or more commands; and
at least one physical data port communicatively coupled to at least one of the processors, the at least one physical data port being removably connectable to a corresponding physical drive controller data port, wherein, while the portable diagnostic tool is communicatively connected to the drive controller, the one or more processors are configured to collectively:
receive an error signal from the drive controller;
identify one of the plurality of instruction sets corresponding to the drive controller model of the plurality of drive controller models that matches the drive controller;
select a corresponding one of the plurality of resolution protocols based on the identified instruction set and the received error signal; and
transmit, to the drive controller, the one or more commands associated with selected resolution protocol instructing the drive controller to automate the selected resolution protocol.

2. The portable diagnostic tool of claim 1, wherein the one or more commands transmitted to the drive controller are transmitted in response to receiving a user approval.

3. The portable diagnostic tool of claim 1, wherein the selected resolution protocol comprises a firmware update for the drive controller.

4. The portable diagnostic tool of claim 1, wherein the at least one physical data port comprises at least one of a universal serial bus (USB) connector and a registered jack (RJ) connector.

5. The portable diagnostic tool of claim 1, wherein the one or more commands transmitted to the drive controller instruct the drive controller to operate the at least one workstation actuator according to the selected resolution protocol.

6. The portable diagnostic tool of claim 1, wherein the one or more commands transmitted to the drive controller instruct the drive controller to (i) move the at least one workstation actuator to a home position, (ii) reverse a movement direction of the at least one workstation actuator, (iii) reset the drive controller, or (iv) turn the drive controller off and then back on.

7. The portable diagnostic tool of claim 1, wherein the one or more processors are further configured to collectively:
select a corresponding one of a plurality of calibration protocols based on the identified instruction set; and
transmit, to the drive controller, one or more commands associated with selected calibration protocol instructing the drive controller to automate the selected calibration protocol,
receive, from the drive controller, one or more calibration signals that comprise calibration data, wherein the selected resolution protocol is calibrated based on the received calibration data.

8. The portable diagnostic tool of claim 1, further comprising a notification device communicatively coupled to at least one of the processors, and wherein, while the portable diagnostic tool is communicatively connected to the drive controller, the one or more processors are further configured to collectively:
transmit one or more user alerts to the notification device in response to one or more of (i) receiving the error signal from the drive controller, (ii) identifying the one of the plurality of instruction sets, (iii) selecting the corresponding one of the plurality of resolution protocols, and (iv) transmitting the one or more commands to the drive controller.

9. The portable diagnostic tool of claim 1, further comprising a visual display communicatively coupled to at least one of the processors, and wherein, while the portable diagnostic tool is communicatively connected to the drive controller, the one or more processors are further configured to collectively:
transmit one or more user messages to the visual display in response to one or more of (i) receiving the error signal from the drive controller, (ii) identifying the one of the plurality of instruction sets, (iii) selecting the corresponding one of the plurality of resolution protocols, and (iv) transmitting the one or more commands to the drive controller.

10. The portable diagnostic tool of claim 1, wherein the at least one workstation actuator comprises a first workstation actuator and a second workstation actuator, and the one or more commands transmitted to the drive controller instruct the drive controller to operate the first workstation actuator and the second workstation actuator according to the selected resolution protocol.

11. The portable diagnostic tool of claim 10, wherein the one or more commands transmitted to the drive controller instruct the drive controller to move one of the first and second workstation actuators an offset distance relative to the other of the first and second workstation actuators to level the first and second workstation actuators.

12. A portable diagnostic tool for a drive controller of a power-actuated workstation, the drive controller operating at least one workstation actuator, the portable diagnostic tool comprising:
one or more processors;
a memory communicatively coupled to at least one of the processors, the memory storing a plurality of computer readable instruction sets, each instruction set being associated with a different drive controller model of a plurality of drive controller models, each instruction set being associated with a plurality of resolution protocols, each resolution protocol being associated with one or more user directions;
at least one physical data port communicatively coupled to at least one of the processors, the at least one physical data port being removably connectable to a corresponding physical drive controller data port; and
a user communication device communicatively coupled to at least one of the processors, the user communication device being communicatively connectable to a user electronic device, wherein, while the portable diagnostic tool is communicatively connected to the drive controller and the user electronic device, the one or more processors are configured to collectively:
receive an error signal from the drive controller;
identify one of the plurality of instruction sets corresponding to the drive controller model of the plurality of drive controller models that matches the drive controller;
select a corresponding one of the plurality of resolution protocols based on the identified instruction set and the received error signal; and
transmit, to the user electronic device, the one or more user directions associated with the selected resolution protocol to perform the selected resolution protocol.

13. The portable diagnostic tool of claim 12, wherein the user communication device is wirelessly connectable to the user electronic device.

14. The portable diagnostic tool of claim 12, wherein the user communication device is wirelessly connectable to the user electronic device by at least one of wireless fidelity (Wi-Fi), Bluetooth®, radio frequency identification (RFID), near-field communication (NFC) and a mobile network.

15. The portable diagnostic tool of claim 12, wherein the user communication device comprises a USB port.

16. A portable diagnostic tool for a drive controller of a power-actuated workstation, the drive controller operating at least one workstation actuator, the portable diagnostic tool comprising:
one or more processors;
a memory communicatively coupled to at least one of the processors, the memory storing a plurality of computer readable local instruction sets, each local instruction set being associated with a different drive controller model of a plurality of drive controller models, each local instruction set being associated with a plurality of local resolution protocols, each local resolution protocol being associated with one or more local commands;
at least one physical data port communicatively coupled to at least one of the processors, the at least one physical data port being removably connectable to a corresponding physical drive controller data port; and
a server communication device communicatively coupled to at least one of the processors, the server communication device being communicatively connectable to a server across a wireless network, wherein, while the portable diagnostic tool is communicatively connected to the drive controller and the server, the one or more processors are configured to collectively:
receive an error signal from the drive controller;
retrieve a computer readable remote instruction set from remote network storage, the remote instruction set corresponding to the drive controller model of the plurality of drive controller models that matches the drive controller, the remote instruction set being associated with a plurality of remote resolution protocols, each remote resolution protocol being associated with one or more remote commands;
select a corresponding one of the plurality of remote resolution protocols based on the identified remote instruction set and the received error signal; and
transmit, to the drive controller, the one or more remote commands associated with the selected remote resolution protocol instructing the drive controller to automate the selected remote resolution protocol.

17. The portable diagnostic tool of claim 16, wherein, while the portable diagnostic tool is communicatively connected to the drive controller and the server, the one or more processors are further configured to collectively:
prior to identifying the remote instruction set in remote network storage, determine that each of the plurality of local instruction sets fail to correspond to the drive controller model of the plurality of drive controller models that matches the drive controller.

18. The portable diagnostic tool of claim 16, wherein the one or more remote commands transmitted to the drive controller instruct the drive controller to operate the at least one workstation actuator according to the selected remote resolution protocol.

19. The portable diagnostic tool of claim 16, wherein the one or more remote commands transmitted to the drive controller are transmitted in response to receiving a user approval.

20. The portable diagnostic tool of claim 16, wherein the selected remote resolution protocol comprises a firmware update for the drive controller.
